(19) United States
(12) Patent Application Publication
(10) Pub. No.: US 2005/0015161 A1
(43) Pub. Date: Jan. 20, 2005

(54) Auxiliary memory device for automation controller

(76) Inventor: Chun-Ching Wang, Taoyuan (TW)

Correspondence Address: RABIN & CHAMPAGNE, P.C., Suite 500, 1101 14 Street, N.W., Washington, DC, 20005, US

(21) Appl. No.: 10/671,491

(22) Filed: Sep. 29, 2003

(30) Foreign Application Priority Data
Jul. 18, 2003 (TW) 92119740

(51) Int. Cl. G05B 19/42

(52) U.S. Cl. 700/87

(57) ABSTRACT

An auxiliary memory device for automation controller is disclosed. The internal data stored in the memory device is delivered to the internal memory device of the controller to update the internal instructions of the controller after connecting the memory device with the connecting interface of the controller. Besides, the internal data of the controller is also backed up to the memory device. Therefore, the expansion of the controller is improved.

### BACKGROUND OF THE INVENTION

1. Field of Invention

The invention relates to a memory device for assisting automation equipment and, in particular, to an auxiliary memory device connecting to an automation controller such as a programmable logic controller or human-machine interface so that the automation controller can be expanded to add memory programs.

2. Related Art

Advance in technologies have helped conventional industries evolve into the automation industry era. During the automation process, many automation controller components are required to facilitate production and to save manpower. When talking about automation controllers, it is necessary to mention the programmable logic controller (PLC). It is a very useful tool that is used by modern factories in procedure automation controls. The PLC is a microcomputer particularly designed for procedure control systems. The production factory downloads an execution procedure using editors to an internal memory unit of the PLC. Afterwards, a logic processing unit follows the control logic defined in the execution procedure to monitor and process input signal entered from buttons, sensors, and/or limit switches. After logical operations, output signals are sent to an external load, such as a relay, indicator, or electric machine. The output signal can also be fed back as the input signal to control other devices if the production line requires.

From the above description, one knows that the PLC contains a logic processing unit and an internal memory unit. The internal memory unit is recorded with instruction program codes. The logic processing unit uses the instruction program codes in the internal memory unit to perform various actions for controlling the production devices. However, the automation production procedure may need to be modified very often. Nevertheless, the instruction program codes are burned into the internal memory unit. Therefore, the user has to rely on an editor to directly modify the codes or has to send the whole PLC back to its manufacturer for updating the instruction program codes once the automation production procedure needs to be changed. This is extremely inconvenient for the production company.

On the other hand, the human-machine interface in the automation controller is the interface between the automation controller and the user. The display information in the human-machine interface is designed according to various kinds of situations. The user's input is received via the keyboard on the screen. Therefore, the interface can have different applications, ranging from machine tool control panels to factory monitoring. However, it has the same data backup and update problem as the PLC. The application would be more convenient if an auxiliary memory device can be provided to these two automation controllers.

### SUMMARY OF THE INVENTION

In view of the foregoing, the invention provides a convenient auxiliary memory device, which uses an external auxiliary memory device to facilitate the applications.

The disclosed auxiliary memory device contains a body and an auxiliary memory device. The automation controller is connected to the auxiliary memory device via a connecting interface. The automation controller is installed with a logic processing unit and an internal memory unit. Once both of them are connected, internal data in the auxiliary memory device can be sent to the internal memory unit of the automation controller according to the user's request. This allows the user to update the internal instructions of the automation controller. Besides, the internal data of the controller is also backed up to the memory device. Therefore, the expansion of the controller is improved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow illustration only, and thus are not limitative of the present invention, and wherein:

FIG. 1 is a schematic block diagram of the disclosed auxiliary memory device for automation controllers;

FIG. 2A is a first detailed view of the disclosed auxiliary memory device;

FIG. 2B is a second detailed view of the disclosed auxiliary memory device; and

FIG. 3 is a flowchart of actions performed by the disclosed auxiliary memory device.

### DETAILED DESCRIPTION OF THE INVENTION

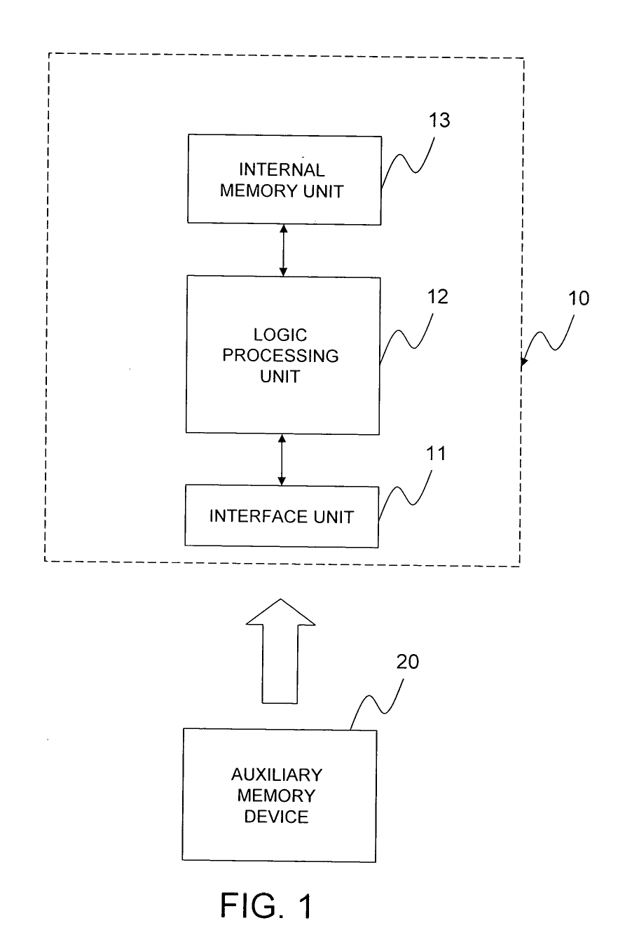

Please refer to FIG. 1 for a schematic block diagram of the disclosed auxiliary memory device for automation controllers. The automation controller 10 contains: an interface unit 11, a logic processing unit 12, and an internal memory unit 13. The internal memory unit 13 stores specific data, which include execution procedure required for factory production. The logic processing unit 12 controls connected factory equipment according to the data in the memory unit 13. The interface unit 11 is connected to the auxiliary memory device 20 for it to update the specific data in the automation controller 10 or to back up the specific data to the auxiliary memory device 20.

In the following paragraphs, we describe the internal structure of the auxiliary memory device in further detail.

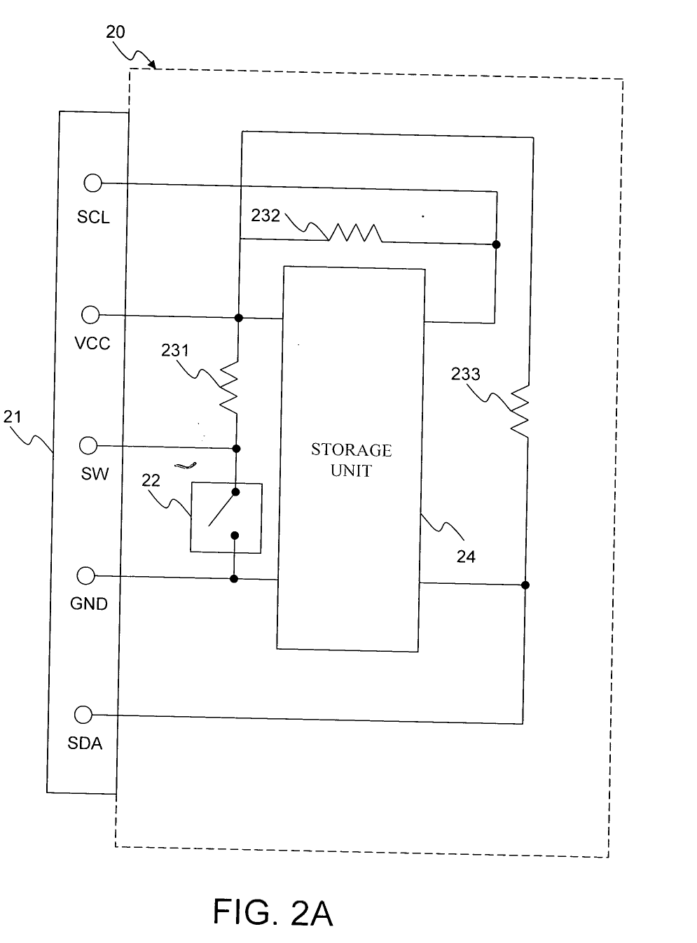

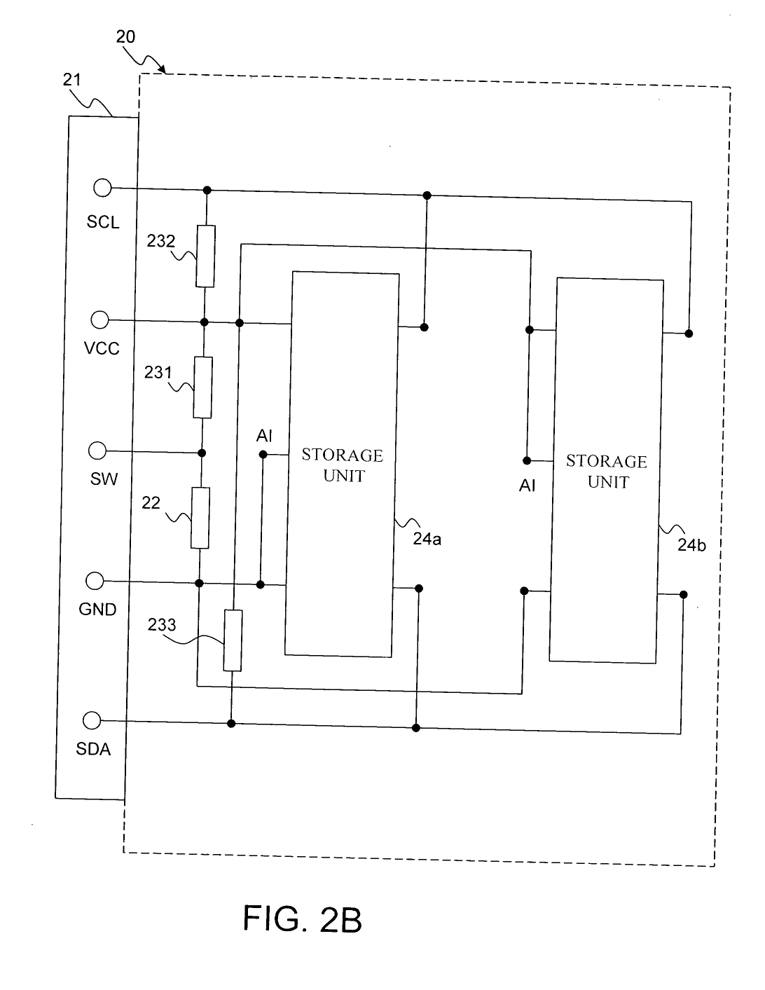

With reference to FIG. 2A, the auxiliary memory device 20 of the invention includes a connecting unit 21, a switching unit 22, a storage unit 24, and a load unit. The connecting unit 21 is installed with a power supply end VCC, a ground end GND, a pulse wave end SCL, a data end SDA, and a switching end SW. The storage unit 24 has a power supply pin, a ground pin, a pulse wave pin, and a data pin. The power supply pin is connected to the power supply end VCC for receiving the work voltage of the automation controller. The ground pin is connected to the ground end GND, forming a common ground loop for the automation controller. The pulse wave pin is connected to the pulse wave end SCL for receiving simulating system clocks sent from the automation controller. The data pin is connected to the data end SDA for transmitting the specific data.

The switching unit 22 is connected to the switching end SW for allowing the user to select the transmission direction of the specific data (for example, from the automation controller to the auxiliary memory device, or vice versa). The load unit is connected to the work power supply and contains a first load component, a second load component, and a third load component. The three load components can all be variable resistors. The first load component is installed between the work voltage and the switching unit 22 and produces a load. The second load is installed between the work voltage and the pulse wave pin to produce a load and to make the pulse wave pin in a pull high voltage. The third load is installed between the work voltage and the data pin and generates a load so that the data pin is in a pull high state.

In addition to the above-mentioned auxiliary memory device, the invention is further designed with another auxiliary memory device to store more of the specific data. With reference to FIG. 2B, the connection methods of the connecting unit 21, the switching unit 22 and the load unit are the same. Another storage unit 24b is connected to the back of the storage unit 24a. Both of the storage units 24a, 24b are installed with connecting ends A1 to represent the connection relation of the storage units. The connection end A1 of the storage unit 24b is connected to the power supply end VCC. The state is 1. The pulse wave pin of storage unit 24a is connected in series to that of the storage unit 24b. The data pin of the storage unit 24a is connected in series to that of the storage unit 24b. This can enhance the memory function.

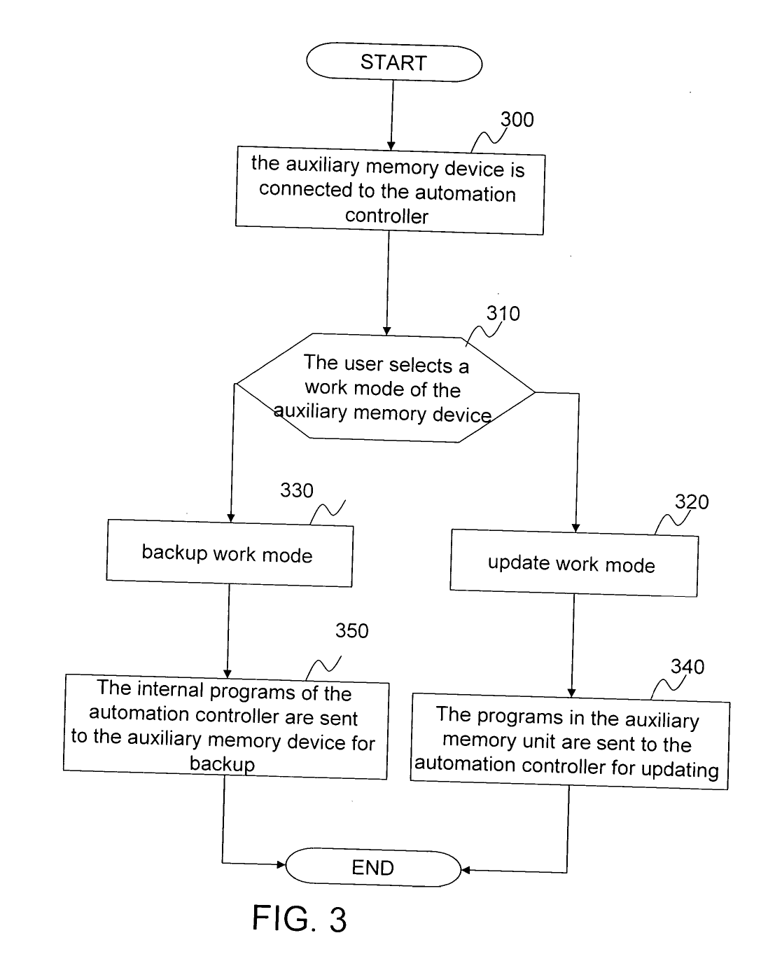

Finally, we explain in detail the specific data update or backup steps. With reference to FIG. 3, to update or back up the specific data, the auxiliary memory device is first connected to the automation controller (step 310). The user then selects a work mode of the auxiliary memory device (step 320). This step is done by controlling the switching unit. If the user selects the update work mode, the switch unit is open. The work power sends the load voltage via the first load unit 231 and the switch end SW to the automation controller 10 (the received level is 1) for receiving the specific data in the storage unit 24. The programs in the auxiliary memory unit are sent to the logic controller for updating (step 340). This completes the updating procedure. If the user selects the backup work mode (step 330), the switching unit is closed. The work power goes through the first load component, delivering the load voltage via the switching unit to the ground end. The automation controller 10 receives a voltage level 0. This transfers the internal programs of the automation controller to the auxiliary memory device for backup (step 350).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An auxiliary memory device for automation controllers, comprising:
a connecting unit, which is connected to the automation controller for transmitting and receiving a specific datum;
a switching unit, which is connected to the connecting unit for switching the transmission directions of the specific datum;
a storage unit, which contains at least one memory element and is connected to the switching unit for storing the specific datum; and
a load unit, which contains a plurality of load components connecting to a work power supply for receiving the work power and generating a load.

2. The auxiliary memory device of claim 1, wherein the storage unit further comprises:
a power supply pin, which is connected to the work power supply for receiving the work power;
a ground pin, which, along with the connecting unit, is connected to a ground end to form a ground loop;
a pulse wave pin, which, along with the connecting unit, is connected to a data end for receiving and transmitting the specific data from the automation controller.

3. The auxiliary memory device of claim 1, wherein the auxiliary memory device transmits the specific datum in the storage unit to the automation controller when the switching unit is closed.

4. The auxiliary memory device of claim 1, wherein the auxiliary memory device receives the specific datum in the storage unit from the automation controller when the switching unit is open.

5. The auxiliary memory device of claim 1, wherein the connecting unit is an RS232 interface.

6. The auxiliary memory device of claim 1, wherein the load components further comprises:
a first load component, which is a resistor for generating a load between the work voltage and the switching unit;
a second load component, which is a resistor for generating a load between the work voltage and the pulse wave pin; and
a third load component, which is a resistor for generating a load between the work voltage and the data pin.
